(19) United States
(12) Patent Application Publication
(10) Pub. No.: US 2016/0341187 A1
(43) Pub. Date: Nov. 24, 2016

(54) RECIPROCATING MOTOR-COMPRESSOR WITH INTEGRATED STIRLING ENGINE

(71) Applicant: NUOVO PIGNONE SRL, Florence (IT)

(72) Inventors: Francesco BUFFA, Florence (IT); Marco SANTINI, Florence (IT); Leonardo TOGNARELLI, Florence (IT); Carmelo MAGGI, Florence (IT)

(21) Appl. No.: 15/114,916

(22) PCT Filed: Jan. 30, 2015
(86) PCT No.: PCT/EP2015/051907

§ 371 Date: Jul. 28, 2016

(30) Foreign Application Priority Data
Jan. 31, 2014 (IT) FI2014A000022

(51) Int. Cl. F04B 35/00; F02G 1/055; F04B 39/12; F04B 27/02; F04B 39/00

(52) U.S. Cl. CPC F04B 35/00; F04B 27/02; F04B 39/0005; F04B 39/0094; F04B 39/12; F02G 1/055; F02G 2280/50

(57) ABSTRACT

The reciprocating motor-compressor comprises a frame wherein a crank-shaft is rotatingly housed. Compressor pistons are drivingly connected to the crankshaft and are reciprocatingly moved thereby in respective compressor cylinders. The crankshaft is driven into rotation by an em-bedded Stirling engine. The Stirling engine comprises at least a hot cylinder and a cold cylinder, wherein a respective hot piston and a respective cold piston are reciprocatingly moving. Thermal power is provided to the hot cylinder and partially converted into mechanical power for driving the reciprocating compressor.

### FIELD OF THE INVENTION

The subject matter disclosed herein concerns improvements to reciprocating motor-compressors.

### BACKGROUND

Reciprocating compressors are used in several industrial fields for boosting the pressure of a gas. Typical applications of reciprocating compressors are in refineries, e.g. in reformer, hydrocracker and hydrotreater plants. Typical applications of reciprocating compressors can be found also in the polymer industry, for manufacturing of ethylene and derivatives.

Reciprocating compressors are typically driven by electric motors, which are powered by electric energy from an electric power distribution grid. In some known embodiments, reciprocating compressors are driven by internal combustion engines, such as reciprocating Diesel or Otto engines. In other installations, steam turbines are used for driving the reciprocating compressors. A large amount of high-quality energy is thus usually needed for driving the compressors. Motor-compressors using Diesel or Otto internal combustion engines are particularly complex and expensive both from the point of view of manufacturing as well as from the viewpoint of maintenance.

### BRIEF DESCRIPTION

The present disclosure suggests an improved reciprocating motor-compressor, which solves or alleviates at least some of the problems of known motor-compressors.

According to the present disclosure, the reciprocating motor-compressor includes a frame wherein a crankshaft is rotatingly housed. Compressor pistons are drivingly connected to the crankshaft and are reciprocatingly moved thereby in respective compressor cylinders. The crankshaft is driven into rotation by an embedded Stirling engine. The Stirling engine includes at least a hot cylinder and a cold cylinder, wherein a respective hot piston and a respective cold piston are reciprocatingly moving. Thermal power is provided to the hot cylinder and partially converted into mechanical power for driving the reciprocating compressor.

Integrating a Stirling engine in a reciprocating compressor as a driver for the reciprocating compressor allows using waste heat, e.g. from exhaust combustion gas of a gas turbine, or from any other source of waste heat in an industrial process, to drive the reciprocating compressor, thus saving high-quality energy, such as electric energy or fossil fuel. In some embodiments, solar energy can be used as a heat source. In some embodiments, a waste cold-flow stream can be used as a cold source, in combination with a hot source at ambient temperature or with a hot source at a temperature higher than ambient temperature.

Mechanical power is made available on the crankshaft for driving the compressor pistons by means of a thermodynamic cyclic transformation performed by a working fluid processed through the Stirling engine according to a closed cycle, the working fluid absorbing high-temperature heat at the hot source and discharging low-temperature heat at the cold source.

Stirling engines can be operated at a relatively low rotational speed, which is particularly useful in driving large reciprocating compressors, especially hyper-compressors.

Among the various potential benefits of a Stirling engine vs. an internal combustion engine, the following are worth noting: a simpler lubrication system is required; no spark plugs, air filters, timing chains and other components of the timing system are required; no fuel injection systems are used; costly, high-quality fossil fuel is not needed.

Additionally, since the size of Stirling cylinders bores can be larger than internal combustion cylinders, the same driving power needed to operate a reciprocating compressor can be generated with a smaller number of cylinders if a Stirling engine is used rather than an internal combustion engine. This makes the overall arrangement simpler and more compact. In some embodiments, the number of reciprocating compressor cylinders is equal to or even smaller than the number of Stirling engine cylinders. For instance, a two-cylinder Stirling engine can operate a two- or four-cylinder reciprocating compressor.

According to some embodiments, a reciprocating motor-compressor can be provided, which includes a frame; a crankshaft rotatingly supported in the frame and including a plurality of crank pins; at least one compression cylinder-piston arrangement, including a compression cylinder and a compression piston reciprocating therein and drivingly connected to a respective one of the crank pins; an embedded Stirling engine having at least one hot cylinder-piston arrangement including a hot cylinder with a hot piston slidingly housed in the hot cylinder; a hot source; at least one cold cylinder-piston arrangement comprised of a cold cylinder with a cold piston slidingly housed in the cold cylinder; a cold source; a fluid connection between the cold cylinder and the hot cylinder, where through a working fluid flows from the hot cylinder to the cold cylinder and vice-versa. The hot piston and the cold piston are drivingly connected to at least one of the crank pins, such that power generated by the Stirling engine drives the at least one compression cylinder-piston arrangement.

According to a further aspect, the subject matter disclosed herein concerns a method of driving a reciprocating compressor, including the steps of providing a crankshaft with a plurality of crank pins in a frame; drivingly connecting at least one reciprocating piston of at least one compression cylinder-piston arrangement to one of the crankshaft; providing a Stirling engine with a hot source, a cold source, a hot piston and a cold piston; drivingly connecting the hot piston and the cold piston of the Stirling engine to the crankshaft; providing thermal power to the Stirling engine; converting at least part of the thermal power into useful mechanical power in the Stirling engine, and driving the reciprocating piston with the mechanical power.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a perspective schematic view of an integrated reciprocating compressor and Stirling engine arrangement;

FIGS. 2 and 3 illustrate schematic cross-sectional views according to lines II-II and III-III of FIG. 1;

FIGS. 4, 5, 6, and 7 illustrate schematics of four exemplary embodiments of crankshaft and relevant piston arrangements according to the present disclosure.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

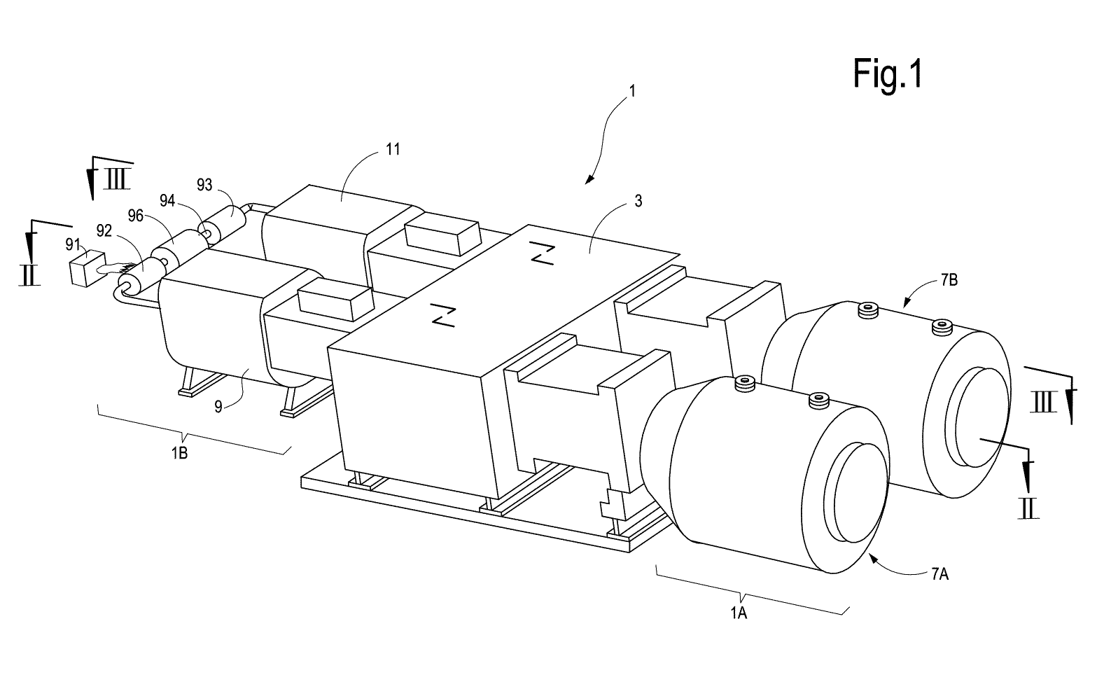

FIG. 1 schematically illustrates a reciprocating compressor with an integrated Stirling engine. The machine 1 includes a frame or crank case 3, wherein a crankshaft 5 is arranged. The crankshaft 5 is drivingly connected to a plurality of reciprocating pistons, which are slidingly housed in respective cylinders. Some of the cylinder-piston arrangements form a reciprocating-compressor section IA of the machine 1, and at least two cylinder-piston arrangements from a Stirling-engine section 1B. In some embodiments the reciprocating-compressor section 1A can include two compression cylinder-piston arrangements 7A, 7B.

The cylinder-piston arrangements of the reciprocating-compressor section 1A can be connected in parallel or in series. In the exemplary embodiment shown in FIGS. 1 to 3 the two cylinder-piston arrangements are connected in series, in that the outlet of the delivery side of the first cylinder-piston arrangement 7A is fluidly connected to the inlet of the second cylinder-piston arrangement 7B. Gas is sequentially processed in the two cylinder-piston arrangements 7A, 7B and therefore the cylinder of the second cylinder-piston arrangement 7B has a smaller volume than the cylinder of the first cylinder-piston arrangement 7A.

In other embodiments only one cylinder-piston arrangement or more than two cylinder-piston arrangements can be provided in the reciprocating-compressor section 1A of machine 1.

The Stirling-engine section 113 of machine 1 includes a hot cylinder-piston arrangement 9 and a cold cylinder-piston arrangement 11.

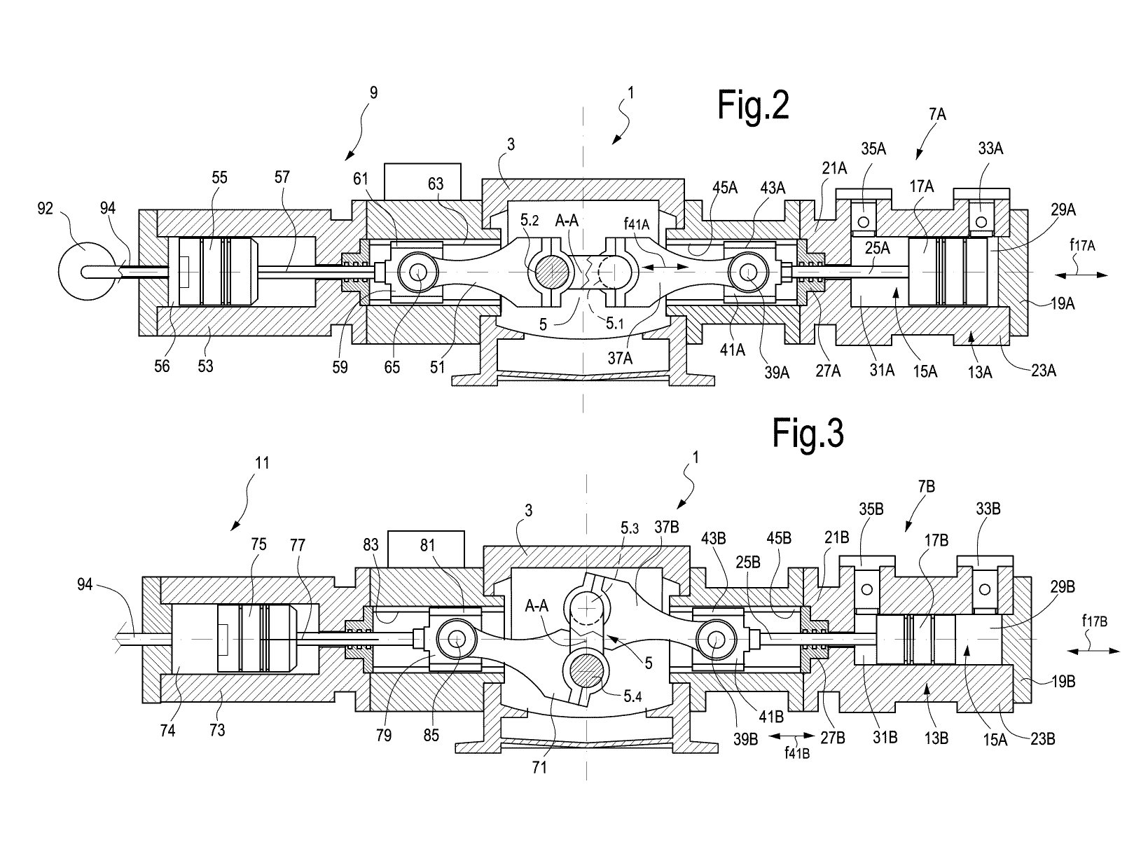

FIGS. 2 and 3 illustrate schematic sectional views according to sectional planes parallel to the piston displacement direction of the machine 1. In the exemplary embodiment shown in FIGS. 2, 3 the reciprocating compressor is a double-effect reciprocating compressor. In other embodiments single-effect reciprocating compressors can be used.

FIG. 2 illustrates a sectional view of the first cylinder-piston arrangement 7A of the reciprocating-compressor section 1A and a sectional view of the hot cylinder-piston arrangement 9 of the Stirling-engine section 1B. FIG. 3 illustrates a sectional view of the second cylinder-piston arrangement 7B and of the cold cylinder-piston arrangement 11.

Referring to FIG. 2, in one embodiment the first cylinder-piston arrangement 7A includes a cylinder 13A having an inner cylindrical cavity 15A housing a piston 17A. The piston 17A is reciprocatingly moving inside the cavity 5 according to double arrow f17A.

The cavity 15A has a head end and a crank end, which can be closed by respective closure elements 19A and 21A. The closure elements can be constrained to a cylindrical barrel 23A. The closure element 21A can be provided with a passage through which a piston rod 25A can extend. Packing cups 27A can provide a sealing around the piston rod 25A. The piston 17A divides the inner cavity 15A of the cylinder 23A into respective first, or head-end chamber 29A and second, or crank-end chamber 31A, respectively.

Each first chamber 29A and second chamber 31A is connected through respective suction valves and discharge valves to a suction duct and a discharge duct, not shown. In some embodiments the suction valves and the discharge valves can be automatic valves, for example so-called ring valves or the like. Suction valve arrangements for the first and second chambers 29A and 31A are shown at 33A and 35A, respectively. The number of suction and discharge valves for each one of the two chambers 29A and 31A can be different, depending upon the dimension and design of the reciprocating compressor.

The reciprocating movement of the piston 17A and of the piston rod 25A is controlled by crankshaft 5 through a respective connecting rod 37A. The connecting rod 37A can be hinged at 39A to a crosshead 41A, which can be provided with crosshead sliding shoes 43A in sliding contact with sliding surfaces 45A. The rotation movement of the crankshaft 5 is converted into reciprocating rectilinear movement of the crosshead 41A according to double arrow f41A. A first end of the piston rod 25A is connected to the crosshead 41A and a second end is connected to the piston 17A, such that the crosshead 41A and the piston 17A reciprocate integrally one with the other.

The big end of the connecting rod 37A is supported on a crank pin 5.1 of crankshaft 5. An adjacent crank pin 5.2 of crankshaft 5 can engage in the big-end hole of a connecting rod 51 of the hot cylinder-piston arrangement 9 of the Stirling-engine section 1B. The hot cylinder-piston arrangement 9 includes a hot-end cylinder 53 and a hot-end piston 55 slidingly housed in the hot-end cylinder 53, forming an expansion chamber 56. The hot-end piston 55 is connected through a hot-end piston rod 57 to a hot-end crosshead 59 in sliding contact through sliding shoes 61 with sliding surfaces 63. The crosshead 59 is pivotally connected at 65 with the small end of the connecting rod 51. When the crankshaft 5 rotates, the hot-end piston 55 reciprocates in the hot-end cylinder 53.

Referring now to FIG. 3, in one embodiment the second cylinder-piston arrangement 7B of the double-effect reciprocating compressor includes a cylinder 13B having an inner cylindrical cavity 15B housing a piston 17B. The piston 17B is reciprocatingly moving inside the cavity 5 according to double arrow f17B.

The cavity 15B has a head end and a crank end, which can be closed by respective closure elements 19B and 21B. The closure elements can be constrained to a cylindrical barrel 23B. The closure element 21B can be provided with a passage through which a piston rod 25B can extend. Packing cups 27B can provide a sealing around the piston rod 25B. The piston 17B divides the inner cavity 15B of the cylinder 23B into respective first or head end chamber 29B and second or crank-end chamber 31B.

Each first chamber 29B and second chamber 31B is connected through respective suction valves and discharge valves to a suction duct and a discharge duct, not shown. In some embodiments the suction valves and the discharge valves can be automatic valves, for example so-called ring valves or the like. Suction valve arrangements for the first and second chambers 29B and 31B are shown at 33B and 35B, respectively. The number of suction and discharge valves for each one of the two chambers 29B and 31B can be different, depending upon the dimension and design of the reciprocating compressor.

The reciprocating movement of the piston 17B and of the piston rod 25B is controlled by crankshaft 5 through a respective connecting rod 37B. The connecting rod 37B can be hinged at 39B to a crosshead 41B, which can be provided with crosshead sliding shoes 43B in sliding contact with sliding surfaces 45B. The rotation movement of the crankshaft 5 is converted into reciprocating rectilinear movement of the crosshead 41B according to double arrow f41B. The piston rod 25B can be connected to the crosshead 41B and to the piston 17B and transmits the movement from the crosshead 41B to the piston 17B.

The big end of the connecting rod 37B is supported on a crank pin 5.3 of crankshaft 5. An adjacent crank pin 5.4 of crankshaft 5 can engage in the big-end hole of a connecting rod 71 of the cold cylinder-piston arrangement 11 of the Stirling-engine section 1B. The cold cylinder-piston arrangement 11 includes a cold-end cylinder 73 and a cold-end piston 75 slidingly housed in the cold-end cylinder 73. A cold compression chamber 74 is formed between cold-end piston 75 and cold-end cylinder 73. The cold-end piston 75 is connected through a cold-end piston rod 77 to a cold-end crosshead 79 in sliding contact through sliding shoes 61 with sliding surfaces 83. The cold-end crosshead 79 is pivotally connected at 85 with the small end of the connecting rod 71. Thus, while the crankshaft 5 rotates, the cold-end piston 75 moves reciprocatingly in the cold-end cylinder 73.

A hot source, i.e. a source of thermal energy, schematically shown at 91 is combined with the hot cylinder-piston arrangement 9 and provides thermal energy at a high temperature to a working fluid which is cyclically moved from the hot-end cylinder 53 to the cold-end cylinder 73 and vice-versa while performing a thermodynamic Stirling cycle.

The hot source 91 can include a burner, where a fuel is burned to generate heat which is transferred, e.g. through a heat exchanger schematically shown at 92, to the working fluid of the Stirling engine.

In some embodiments the hot source can be a waste heat recovery system, where waste heat is transferred to the working fluid. For example, heat from the exhaust combustion gas of a gas turbine can be transferred to the working fluid of the Stirling engine. A separate heat-transfer loop (not shown) where a heat transfer fluid is circulated, can be used to transfer heat from the waste heat source to the Stirling engine. Diathermic oil, water or any other suitable heat transfer fluid can be circulated in the loop and exchange heat with the exhaust combustion gas from a gas turbine on one side and with the working fluid of the Stirling engine on the other.

A cold source or heat sink 93 is combined with the cold cylinder-piston arrangement 11. Low-temperature heat (i.e. thermal energy at a temperature lower than the temperature of the thermal energy provided by the hot source 91) is removed from the working fluid at the cold source 93. A passage or duct 94 connects the hot-end cylinder 53 to the cold-end cylinder 73. The cold source or heat sink 93 can include a heat exchanger, for example an air heat exchanger, where the working fluid of the Stirling engine is cooled by discharging low-temperature heat in ambient air. A water heat exchanger can also be used as a heat sink, whereby low-temperature heat is removed from the working fluid of the Stirling engine by circulating cold water. A heat regenerator 96 can be arranged along duct 94.

In some embodiments the heat sink can include a cold source where heat is removed at a temperature lower than the ambient temperature. For instance, a cold fluid from an expansion process, a refrigerant of a refrigeration circuit or the like can be used as a cold source. A cold source can be provided by a regasification process, where heat is removed from the cold source and used to gasify liquid natural gas (LNG). In this case heat removal from the cold source of the Stirling engine is provided by heat exchange with a flow of waste cold fluid.

In some embodiments, where the cold source is below ambient temperature, the hot source can be at ambient temperature. If the temperature of the cold source is sufficiently lower than the ambient temperature, the hot source can be ambient air itself.

Usually, a temperature drop between hot source and cold source of 200° C. or more is suitable for operating a Stirling engine embedded in an integrated reciprocating motor-compressor, as the one illustrated in FIGS. 1 to 3.

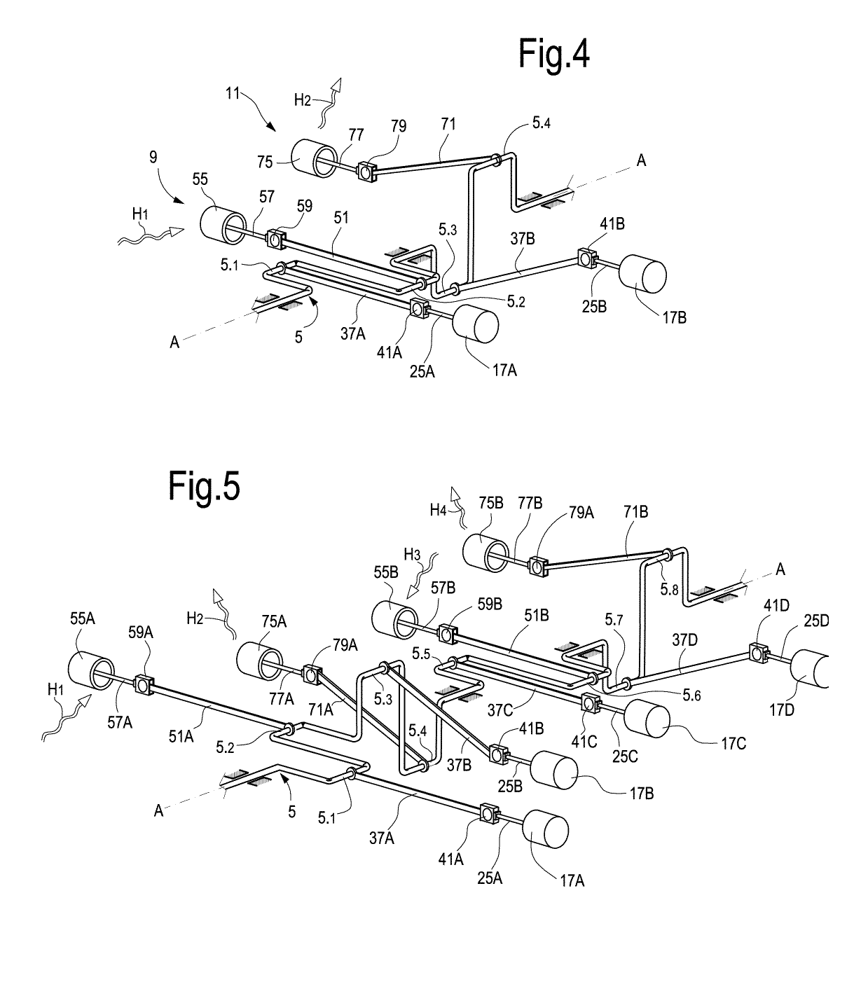

The angular positions of the crank pins 5.1-5.4 can be better appreciated from FIG. 4, where only the center line of the crankshaft 5 is shown, together with a very schematic representation of the pistons, connecting rods, piston rods and crossheads of the machine 1. The components schematically shown in FIG. 4 are labeled with the same reference numbers as used in FIGS. 1 to 3.

As shown in FIGS. 2, 3 and 4, the two crank pins 5.1, 5.2 are angularly shifted by 180° one with respect to the other; the crankpins 5.3, 5.4 are shifted by 180° one with respect to the other; and crank pins 5.2 and 5.3 are shifted by 90°. The two pistons of the Stirling-engine section 1B are thus phased at 90° one with respect to the other. The Stirling engine is entirely integrated in the reciprocating machine as Stirling-engine section 1B, and shares crankshaft, frame, bearings and lubrication system (including the lubrication oil pump and cooler, if any) of the reciprocating-compressor section 1B.

In the schematic of FIG. 4 high-temperature heat delivered at the hot side of the Stirling engine is represented by arrow H1 and low-temperature heat removed from the cold side of the Stirling engine is represented by arrow H2.

The operation of a Stirling engine is known from the art and will not be described in detail herein. Suffice it to recall that once the reciprocating movement of the hot-end piston 55 in the hot-end cylinder 53 and of the cold-end piston 75 in the cold-end cylinder 73 is initiated, it will continue thanks to the thermal power delivered at the hot end, which is partly converted into mechanical power available on the crankshaft, while the non-converted thermal energy is discharged at the cold sink. Energy conversion is performed by the cyclic thermodynamic transformation undergone by the working fluid contained in the closed system formed by the two cylinder-piston systems 9, 11, heat regenerator 96, cooler 93, heater 92, as well as duct 94, connecting them to one another.

The mechanical power thus generated by the Stirling engine formed by the two cylinder-piston systems 9, 11 and relevant connection duct, hot source and cold source, is used to drive the crankshaft 5 and compress the gas in the reciprocating-compressor section 1A of the reciprocating machine 1. A flywheel (not shown) is provided on the crankshaft 5 and assists in keeping the crankshaft in continuous rotational motion.

Larger machines including a larger number of reciprocating-compressor pistons and Stirling-engine pistons can be designed, based on the same concept. FIG. 5 illustrates, in the same schematic manner as FIG. 4, the arrangement of a crankshaft, crank pins, connecting rods, cross-heads and pistons in an integrated reciprocating motor-compressor including four reciprocating compressor pistons and a dual Stirling engine, including two cold cylinder-piston arrangements and two hot cylinder-piston arrangements. More specifically, in the embodiment of FIG. 5 a crank-shaft 5 with eight crank pins 5.1, 5.2, 5.3, 5.4, 5.5, 5.6, 5.7 and 5.8 is shown. The rotation axis of crankshaft 5 is shown at A-A.

In FIG. 5 the components and elements of the four cylinder-piston systems of the reciprocating compressor section 1A are labeled with the same reference numbers as used in FIGS. 2 and 3 followed by the letters A, B, C, D for the four cylinder-piston arrangements. In this embodiment the Stirling-engine machine section 1B includes four cylinder-piston units, namely two hot cylinder-piston arrangements and two cold cylinder-piston arrangements. The components of the two pairs of arrangements are labeled with the same reference numbers used for the hot and cold cylinder-piston arrangements 9 and 11 shown in FIGS. 1, 2 and 3, followed by the letters A and B, respectively. In some embodiments, the position of the two hot pistons and of the two cold pistons in the two pairs are shifted by 180°, i.e. the crank pin 5.2 drivingly connected with the hot piston 55A is shifted by 180° with respect to the crank pin 5.6 of the hot piston 55B. Similarly, the cold piston 75A is drivingly connected with crank pin 5.4, which is angularly shifted by 180° with respect to the crank pin 5.8 which is drivingly connected to the cold piston 75B. Since the hot piston and cold piston of each pair must be shifted by 90°, the crank pins 5.2 and 5.4 are phased at 90° with one another, and the crankpins 5.6, 5.8 are phased at 90°.

The structure of the crankshaft 5 in FIG. 5 is the same as in an 8-cylinder reciprocating compressor with external drive. The resulting integrated motor-compressor therefore uses the same frame 3 and crankshaft 5 of an existing 8-cylinder reciprocating compressor, but incorporates an embedded Stirling engine, which shares part of the structure and auxiliaries of the reciprocating compressor section, namely frame 3, the crankshaft 5, bearings, lubrication circuit etc.

In the schematic of FIG. 5 high-temperature heat delivered at the hot side of the Stirling engine is represented by arrows H1 and H3; low-temperature heat removed from the cold side of the Stirling engine is represented by arrows H2 and H4.

In a four-cylinder or eight cylinder machine, the crankshaft designed for the corresponding reciprocating compressor having four and respectively eight compression cylinder-piston arrangements can be used without redesigning the crankshaft.

In other embodiments, an integrated reciprocating machine with a Stirling-engine section and a reciprocating-compressor section can be designed, with a different number of cylinders. For example, a six-cylinder machine can be designed, having two Stirling-engine cylinder-piston arrangements in a Stirling-engine section and four reciprocating compressor cylinder-piston arrangements. In order to obtain the correct phasing of the Stirling-engine pistons, however, in this case a dedicated crankshaft has to be designed.

The embodiments of FIGS. 1-5 include crank pins, each of which drives a single cylinder-piston arrangement, for instance a double-effect cylinder-piston arrangement.

Known reciprocating compressors exist, wherein one and the same crank pin drives two opposite cylinder-piston arrangements, which are phased at 180° one with respect to the other. Typically, embodiments where a single crank pin drives opposite pistons are used in hyper-compressors.

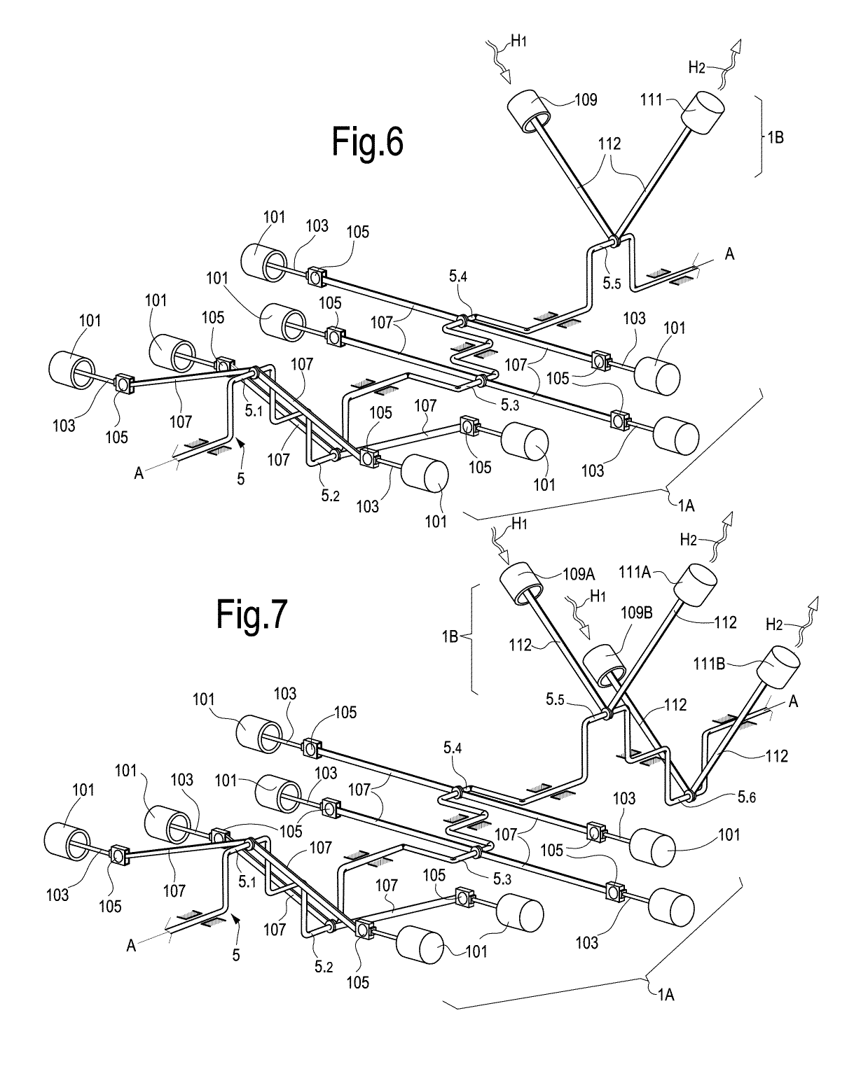

FIGS. 6 and 7 schematically illustrate exemplary structures of a crankshaft for driving integrated reciprocating motor-compressors using an embedded Stirling engine and multiple reciprocating-compressor cylinder-piston arrangements.

Referring to FIG. 6, the crankshaft 5 is supported in a frame (not shown) and includes five crank pins labeled 5.1-5.5. Crank pins 5.1-5.4 are drivingly connected to four pairs of compressor pistons, cumulatively labeled 101. In the exemplary embodiment of FIG. 6 each crank pin 5.1-5.5 drives two opposed pistons 101, which are shifted by 180° Each piston can be part of a single-effect cylinder-piston system. Each piston 101 can be drivingly connected to the respective crank pin 5.1-5.4 by means of respective piston rod 103, crosshead 105 and connecting rod 107.

As known to those skilled in the art of reciprocating compressors and specifically of reciprocating hyper-compressors, in other embodiments each crank pin can be drivingly connected to a pair of opposite, single-effect pistons by means of a single connecting rod, which reciprocates a central crosshead. Piston rods are connected at two opposed sides of the central crosshead and are reciprocated thereby. Additional auxiliary cross-heads can be arranged along the piston rod.

In some hyper-compressors the piston rod is slidingly housed in the cylinder and the end portion thereof forms the actual piston.

The cylinder-piston arrangements can be grouped in a reciprocating-compressor section 1A of the integrated reciprocating compressor.

The crankshaft 5 is driven into rotation by a Stirling-engine section which shares the same crankshaft and the same frame. The Stirling-engine section can include a hot cylinder-piston arrangement and a cold cylinder-piston arrangement substantially as known in the art. In FIG. 6 the Stirling-engine section 1B is represented schematically by a hot piston 109 and a cold piston 111, slidingly housed in a hot cylinder and a cold cylinder, respectively (not shown). The hot cylinder-piston arrangement and the cold cylinder-piston arrangement are arranged at approximately 90° to one another. In the exemplary embodiment of FIG. 6 the two cylinder-piston arrangements of the Stirling engine are driven by the same crank pin 5.5. For the sake of simplicity, the connection between crank pin 5.5 and pistons 109, 111 is represented as including just a respective connecting rod 112. In other embodiments, a driving connection including a connecting rod, a crosshead and a piston rod can be used, instead, quite in the same way as disclosed with reference to FIGS. 1 to 5.

In some embodiments, the two cylinder-piston arrangements of the Stirling engine can be positioned one parallel to the other and driven by two different crank pins angularly shifted by 90° one with respect to the other.

Arrows H1 and H2 schematically represent the high-temperature thermal energy delivered to the hot-end of the Stirling engine and the low-temperature thermal energy removed at the cold-end of the Stirling engine.

FIG. 7 illustrates a similar embodiment, wherein the Stirling-engine section 1B of the integrated, reciprocating machine includes a double Stirling engine, with two hot cylinder-piston arrangements and two cold cylinder-piston arrangements. The same reference numbers are used to designate the same or equivalent components as in FIG. 6. The hot-end pistons are labeled 109A and 109B and the cold-end pistons are labeled 111A, 111B. Arrows H1 and H2 represent heat delivered at the hot source and removed at the cold source of the Stirling engine, respectively. The two pairs of Stirling engine cylinder-piston arrangements are angularly displaced by 180° and are driven by two crank pins 5.5 and 5.6.

In some embodiments, the crankshaft 5 can rotate at a speed comprised e.g. between 150 and 1500 rpm, lower speeds being particularly suitable for hyper-compressors.

In the above described embodiments, a starting motor can be provided, which starts rotation of the crankshaft 5. For instance, an electric starting motor can be provided at either one or the other of the free ends of the crankshaft, outside or inside the frame 5.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. Different features, structures and instrumentalities of the various embodiments can be differently combined.

What is claimed is:

1. A reciprocating motor-compressor comprising:
a frame;
a crankshaft rotatingly supported in said frame and comprised of a plurality of crank pins;
at least one compression cylinder-piston arrangement, comprised of a compression cylinder and a compression piston reciprocating therein and drivingly connected to a respective one of said crank pins;
an embedded Stirling engine having:
at least one hot cylinder-piston arrangement comprised of a hot cylinder with a hot piston slidingly housed in said hot cylinder;
a hot source;
at least one cold cylinder-piston arrangement comprised of a cold cylinder with a cold piston slidingly housed in said cold cylinder;
a cold source; and
a fluid connection between the cold cylinder and the hot cylinder, wherein a working fluid flows through the fluid connection from the hot cylinder to the cold cylinder and vice-versa; wherein the hot piston and the cold piston are drivingly connected to at least one of said crank pins, such that power generated by said Stirling engine drives said at least one compression cylinder-piston arrangement.

2. The reciprocating motor-compressor of claim 1, wherein:
said hot piston is connected to a first of said crank pins and said cold piston is connected to a second of said crank pins.

3. The reciprocating motor-compressor of claim 1, wherein said hot piston and said cold piston are connected to a common crank pin.

4. The reciprocating motor-compressor of claim 1, comprising at least two compression pistons connected to two respective crank pins of said crankshaft, and arranged at approximately 180° one with respect to the other.

5. The reciprocating motor-compressor of claim 1, wherein said at least one compression cylinder-piston arrangement is a double-effect compression cylinder-piston arrangement.

6. The reciprocating motor-compressor of claim 1, to wherein said at least one compression cylinder-piston arrangement is a single-effect compression cylinder-piston arrangement.

7. The reciprocating motor-compressor of claim 1, comprising at least two compression cylinder-piston arrangements, wherein the pistons are connected to a common crank pin.

8. The reciprocating motor-compressor of claim 1, comprising a number N of compression cylinder-piston arrangements, wherein N is equal to or larger than the number of hot cylinder-piston arrangements of said Stirling engine.

9. The reciprocating motor-compressor of claim 1, wherein said crankshaft is rotated at a speed comprised between 200 and 1500 rpm.

10. The reciprocating motor-compressor of claim 1, wherein a temperature difference equal to or higher than 200° C. is provided between the hot source and the cold source.

11. A system comprising a reciprocating compressor according to claim 1, and a waste heat source in thermal contact with the hot source of the Stirling engine.

12. A system comprising a reciprocating compressor according to claim 1, and wherein a cold fluid flow is in thermal contact with the cold source of the Stirling engine.

13. A method of driving a reciprocating compressor, comprising the steps of:
providing a crankshaft with a plurality of crank pins in a frame;
drivingly connecting at least one reciprocating piston of at least one compression cylinder-piston arrangement to one of said crankshaft;
providing a Stirling engine with a hot source, a cold source, a hot piston, and a cold piston;
drivingly connecting the hot piston and the cold piston of the Stirling engine to said crankshaft;
providing thermal power to said Stirling engine;
converting at least part of the thermal power into useful mechanical power in said Stirling engine; and
driving the reciprocating piston with said mechanical power.

14. The method of claim 13, wherein said thermal power is provided by a waste heat source.

15. The method of claim 13, wherein low-temperature heat is removed from the cold source of the Stirling engine by heat exchange with a flow of waste cold fluid.

16. The method of claim 13, wherein a temperature difference of 200° C. or more is applied between the hot source and the cold source.

17. The method of claim 13, wherein said crankshaft is rotated at a speed between 150 and 1500 rpm.
